(19) United States
(12) Patent Application Publication
(10) Pub. No.: US 2002/0049622 A1
(43) Pub. Date: Apr. 25, 2002

(54) Vertical systems and methods for providing shipping and logistics services, operations and products to an industry

(76) Inventors: Anthony R. Lettich, Johnson City, TN (US); Barry W. Dale, Dunwoody, GA (US); Mark F. Bledsoe, Weber City, VA (US); Fred A. Buehler, Kingsport, TN (US); Rajesh U. Mehta, Kingsport, TN (US); Beat Schweizer, Smyrna, GA (US)

Correspondence Address: Charles W. Calkins, Kilpatrick Stockton LLP, 1001 W. 4th Street, Winston-Salem, NC, 27101, US

(21) Appl. No.: 09/843,392

(22) Filed: Apr. 26, 2001

Related U.S. Application Data
(60) Provisional application No. 60/200,035, filed on Apr. 27, 2000.

(51) Int. Cl. G06F 17/60

(52) U.S. Cl. 705/7

(57) ABSTRACT

The present invention provides a vertical system and method for providing shipping and logistics services, operations and products to the chemical industry. The present invention integrates shipping and logistics services, operations and products that are currently provided by multiple entities into a vertical system that may be presented as a site on the world wide web and provide a user with “one stop” shopping for shipping and logistics services, operations and products by acting as a supply chain integrator to assemble and manage resources, capabilities, and technologies of the user's own organization with those of complementary service providers, thereby enabling manufacturers/producers and logistics service suppliers, both asset based and non-asset based, to collaborate without losing their individual status and identity in the supply chain.

### RELATED PATENT APPLICATION

This application claims priority under 35 USC 119 to, and incorporates by reference, United States Provisional Patent Application Ser. No. 60/200,035, entitled “Vertical Systems and Methods for Providing Shipping and Logistics Services, Operations and Products to an Industry.”

### FIELD OF THE INVENTION

The present invention relates to vertical systems and methods for providing shipping and logistics services, operations and products to an industry. The systems and methods of the present invention integrate shipping and logistics services, operations and products that are currently provided by multiple entities into a vertical system that may be advantageously provided by a single entity to facilitate logistics operations, such as the shipping, transporting, warehousing, and distribution of products. An embodiment of the present invention, presented as a site on the world wide web, provides a user, such as a manufacturer, with “one stop” shopping for shipping and logistics services, operations and products by acting as a supply chain integrator to assemble and manage resources, capabilities, and technologies of the user's own organization with those of complementary service providers, thereby enabling manufacturers/producers and logistics service suppliers, both asset based and non-asset based, to collaborate without losing their individual status and identity in the supply chain. An embodiment of the systems and methods of the present invention are particularly advantageous for use in providing shipping and logistic services, operations and products to the chemical industry.

### BACKGROUND

The recent trends of global sourcing, new information technologies, and increasing pressure from customers on the responsiveness and reliability of logistics networks have had an effect on the way companies view their core business. Many companies now view logistics as a key component of their core business strategy and as a means and system for enabling them to meet the challenges of rising global networks.

As companies recognize the strategic importance of logistics in this new global competitive environment, supply chain management is considered increasingly important for overall company performance. Companies in all regions are increasingly involving suppliers and customers in supply chain processes in order to improve their supply chain effectiveness and to move the scope of their supply chain from a local and national level to a regional and global realm.

Improvements in cycle time, delivery time, asset utilization and inventory handling resulting from the employment of enhanced information technology systems as well as improved management of waste materials and returned goods are key elements of logistics improvement. However, despite shorter lead times, shorter delivery cycles, and global operations, companies continue to strive to decrease logistics costs.

The single most important factor when a company considers outsourcing shipping and logistics functions is financial advantages. Outsourcing remains the preferred method of reducing operating costs. A growing group of companies, however, have realized the strategic advantages of value added partnerships with capable shipping and logistics providers.

The use of information technologies is regarded as the major enabler to achieve more efficient customer-oriented supply chains, and an increasing number of companies are taking advantage of new information technologies to facilitate supply-chain-wide communication and integration and to intensify customer relations. Sharing information with customers, suppliers and logistics providers enables companies to know exactly what is happening in the supply chain. Companies have discovered that having the right information, in the right place, at the right time, facilitates logistics decision-making and ultimately creates competitive advantage.

Existing transport mode specific models, however, are “mode-focused” and not customer/industry focused. The methods and systems of the present invention overcome the shortcomings inherent in mode-focused transport models by providing an industry-focused, and accordingly specialized, shipping/logistics capability that can be targeted at a specific industry such as, for example, the chemical industry. By doing so, the present invention enables beneficial gains in the area of higher asset utilization which in turn results in more cost effective logistics solutions for the focal industry.

The methods and systems of the present invention not only improve shipping and logistics management, but also create a new external solution (out-sourcing) model for the focal industries. The methods and systems of the present invention provide a viable alternative to traditional third-party logistics provider (3PL) outsourcing scenarios by providing a community having industry specific domain expertise able to provide new and novel shipping and logistics systems and methods. In one embodiment, the present invention provides a chemical customer/chemical industry focused, global solution rather than the mode specific, regional focus of existing companies.

### SUMMARY OF THE INVENTION

The present invention provides systems and methods that overcome the foregoing disadvantages and facilitate interaction among shipping and logistics suppliers and users with advantages to each.

An aspect of the present invention is a community which acts as a fourth party logistics provider (4PL) for a target industry, such as the chemical industry. In an embodiment of the present invention, the community comprises users and suppliers of shipping and logistics services, operations and products in a particular industry. The community may exist on many levels and may comprise an entire industry on one level and/or one or more segments of that industry on other levels.

In an embodiment of the present invention, a global, e-logistics software infrastructure is provided which allows creation of a neutral solution addressing the inefficiencies of industry supply chains.

In another embodiment of the present invention, shipping and logistics users (for example, manufacturers and producers) and shipping and logistics service, operations and product suppliers, both asset based and non-asset based, are provided with a system and method for collaboration which maintains individual status and identity in the supply chain.

In another embodiment of the present invention, a system and a method is provided which enables shipping and logistics users and suppliers to achieve increased labor productivity, lower costs, more reliable deliveries, and increased visibility of product in transit.

In another embodiment of the present invention, a system and a method is provided which enables third-party suppliers of shipping and logistics services, operations and products to achieve cost and service improvements in their niche markets through access to leading edge tools and leverage.

In another embodiment of the present invention, a system and a method is provided which enables individual shipping and logistics service, operations and products suppliers to achieve higher asset utilization and increased productivity through better coordination of volume streams requiring specialized logistics assets.

In another embodiment of the present invention, a system and a method is provided which enables customers to make informed choices about shipping and logistics service, operations and products packages at the time an order is placed.

In another embodiment of the present invention, a system and a method is provided which enables customer access to total cost (for example, total landed costs, product price, taxes, fees, and freight) associated with various delivery options, and by doing so, enables customers to select the best value to meet an individual need.

In another embodiment of the present invention, a system and a method is provided which provides sufficient flexibility to enables firms to choose desired products and service(s) ranging, for example, from transacting one shipment for a very nominal transaction fee to total outsourcing of shipping and logistics services and operations globally.

In another embodiment of the present invention, a system and a method is provided which enables customers to create a personalized package of value adding shipping and logistics services, operations and products, thereby enabling customers to choose and pay for only those services and products needed.

In another embodiment of the present invention, a system and a method as described is provided which is neutral across all players in the supply chain thus assuring that advantage goes only to the firms providing the highest service at the most attractive price.

In another embodiment of the present invention, an e-commerce site on the world wide web is provided which comprises one or more of the following: community building services; content/value-added services; and commerce enabling services, with each set of services comprising one or more of the services discussed herein. The e-commerce site may comprise a “vertical” business model that provides vertical chain services to an industry from supplier to manufacturer and possibly further to the ultimate end users. The terminology “vertical” business model is utilized to describe a model wherein the e-commerce site of the present invention provides services throughout the supply chain.

As will be appreciated from the foregoing and subsequent descriptions, the present invention provides many advantages to an industry or an industry segment. The web site of the present invention provides an integrated “one stop” source of shipping and logistics information, products, services and operations to an industry and simplifies the buying and selling of the same. Well informed participants performing transactions in real-time will help to ensure the efficiency of the market. Also, the Commerce-enabling services of the invention will allow suppliers to more effectively market to the professionals in an industry who make purchase decisions. Furthermore, the efficiencies gained through the implementation of these commerce services will reduce costs associated with the procurement of shipping and logistics information, products, services and operations to an industry by automating and aggregating the ordering and related interactions between the various participants in the community.

Further details and advantages of the present invention are set forth below.

### BRIEF DESCRIPTION OF THE FIGURES

These and other features, aspects, and advantages of the present invention are better understood when the following Detailed Description of the Invention is read with reference to the accompanying drawings, wherein

FIG. 1 shows an embodiment of a computer system in accordance with the present invention, including a web server, an application server and a database server hosted by an application service provider.

FIG. 2 shows an embodiment of a computer system in accordance with the present system that facilitates the integration of a plurality of trading partners.

FIG. 3 shows an embodiment of the steps a basic consumer transaction in accordance with the present invention.

### DETAILED DESCRIPTION OF THE INVENTION

The present invention provides systems and methods to facilitate commerce in an industry marketplace. According to the present invention a community is built of users and suppliers of shipping and logistics services, operations and products in a target industry. The community acts as a fourth party logistics provider for a target industry, such as the chemical industry. The community may exist on many levels and may comprise an entire industry on one level and one or more segments of that industry on other levels.

An embodiment of a system of the present invention comprises: A system for facilitating commerce in an industry marketplace comprising a community of participants in a target industry comprising:

a computer network;

a market segment within the industry;

a database for information relevant to the industry or to the market segment accessible via the computer network, the database comprising at least one of the following: data, a value-added service; a commerce service; and

an interface, wherein the interface provides access to the information.

The computer network may comprise a wide area network, the Internet, or the like.

1. The Community

In a preferred embodiment, the community may comprise a “virtual” community, such as, for example, as a site on a computer network (e.g., the world wide web, a corporate intranet, a government/military network, or the like). Preferably, for ease of access to the widest number of participants, the virtual community is implemented as a site on the world wide web (internet). Currently available hardware platforms, including PC's, minicomputers and mainframes, and currently available operating systems, including UNIX, MS Windows, Mac OS and Linux, can be utilized to host the site. The community aspect of the present invention may be implemented utilizing currently available software authoring tools for the world wide web and other currently available software products.

In an embodiment of the present invention, the community comprises a single market segment within a single industry. In a further preferred embodiment, the scope, make-up and size of the community may vary depending on the make-up, size and scope of the relevant market segment within a target industry, and as the market segment fluctuates, so may the community.

a. Members

A user of the system of the present invention may comprise a participant in the target industry and/or market segment of the industry. For example, in an embodiment of the present invention wherein the industry is the chemical industry, the community may comprise users and suppliers (of shipping and logistics services, operations and products). In another embodiment of the present invention, the community may comprise members of distinct levels of membership, wherein the membership levels are structured to meet the various needs of the users and suppliers in the target industry supply chain.

In a preferred embodiment, for example, said members would comprise one or more of the following:

an equity member;

a commission based member;

a transaction user member; and

a referral member.

Examples of said members are described in further detail below:

Equity memberships available, for example, to those target industry firms who wish to invest in the community. Said equity members may comprise users who invest capital and commit major parts of their logistics transactions thereby helping the community of the present invention to rapidly achieve critical mass for network efficiencies. Said equity members would benefit from expected appreciation of their capital investment, and the opportunity to influence the evolution of the community and the service offerings therein. Said equity memberships, for example, would be critical to rapidly demonstrating neutrality.

Commission based memberships available, for example, to industry companies/firms who wish to outsource entire portions of their logistics functions. Since the outsourced functions are generally not strictly transaction based, said commission based members can be provided with service contracts, for example, which would require a commission to be paid to the community based on gain sharing of saving achieved. Said commission contracts may be flexible and based on the shipping/logistics package desired.

Transaction user memberships available, for example, to industry companies/firms who wish to maintain more control over their logistics functions, but also want to achieve the savings and service improvements available with the community's service offerings. Said transaction user members may, for example, choose to enter their own negotiated rates with carriers of their choice, or they can access the broader service provider community to put their shipments/logistics needs out for bid. They may also, for example, choose to use contracts negotiated by the community. Thus, any level of usage could be available from one shipment to all shipments. Said transaction user members, thus, could be in complete control of each transaction and pay only for those transactions they choose to use.

Referral memberships available, for example, to industry service providers who wish to participate to benefit from business referral from the community of the present invention. A schedule of referral fees based on the value of the business referred could be used, for example, to define the compensation received by said referral members.

b. Services

In a further embodiment of the present invention, the community comprises one or more providers, said providers comprising one or more providers of shipping, logistics, and/or operations services and/or products, wherein said services may, for example, address the needs of various users and suppliers in the target industry supply chain. In an embodiment of the present invention, the services, operations and products may comprise one or more of the following:

logistics operations execution;

logistics network optimization;

logistics compliance management; and

logistics procurement functionality.

Examples of said services, operations and products are described in further detail below:

Logistics operations execution in order, for example, to increase labor productivity and asset utilization;

Logistics network optimization in order, for example, to lower costs for both shippers and service providers by intelligently mixing and matching the shipping/logistics requirements of the member community to more fully utilize the assets of the entire community;

Logistics compliance management in order, for example, to leverage intellectual capital and alliances across the entire member community, and by doing so, significantly lower the cost of compliance with global trade regulations, country specific documentation requirements, industry codes of conduct, and Department of Transportation (DOT)/United Nations Hazardous Material (HAZMAT) Regulations, among others; and

Logistics procurement functionality in order, for example, to facilitate consortium contract negotiation, and by doing so, increase volumes thereby increasing business allocations to those service suppliers who provide the best, most economical services, and thereby lower cost and more efficient operations accruing to both users and service providers.

c. Revenue Sources

In a further embodiment of the present invention the systems and methods further comprise systems and methods for receipt of one or more types of revenue, thereby allowing the community to remain independent and self-supporting. In an embodiment of the present invention, the revenue types may comprise one or more of the following:

transaction fees;

commission revenues;

subscription fees; and

referral fees.

Examples of said revenue types and sources are described in further detail below:

Transaction fees, for example, may be received from all users of the portal of the community providing a continual revenue stream into the community. The fee schedule for each transaction is preferably nominal in relation to the actual logistics cost involved. Thus, in a preferred embodiment, although individual fees are nominal, the total transaction fees constitute a significant, on-going source of revenue.

Commission revenues, for example, may be received by the community from those industry partners who wish to delegate responsibility for entire portions of their logistics activities. In a preferred embodiment, contracts providing for commission revenues are based on gain sharing from the productivity achieved. Commission revenues may also, for example, accrue to the community as a result of freight savings accomplished through collaboration. In a further embodiment, savings obtained through other advantages of the systems and methods of the present invention, such as increased volume leverage, spot auction rates, optimizing asset utilization and optimizing logistics processes, can optionally also be split between the community and users of the community portal through a variety of pricing mechanisms.

Subscription fees and/or referral fees, for example, may be received by the community of the present invention from those shipping and logistics suppliers who obtain incremental business directly from a referral.

d. Points of Leverage/Advantages

In a further embodiment of the present invention, the community may comprise one or more virtual fourth party shipping and logistics providers acting as a supply chain integrator to assemble and manage resources, capabilities, and technologies of user organizations with those of complementary service providers. In a preferred embodiment, the present invention comprises a logistics software infrastructure which allows the creation of a neutral solution addressing the inefficiencies of a target industry supply chain. Said infrastructure enables producers and logistics service suppliers, both asset based and non-asset based, to collaborate without losing their individual status or identity in the supply chain.

In a further embodiment, the present invention comprises systems and methods able to leverage one or more of the following supply chain components:

procurement;

distribution;

warehousing;

reverse logistics; and

logistics costs.

Said supply chain components are discussed in further detail below:

Procurement. The methods and systems of the present invention recognize that as the first element of the supply chain, procurement, is of strategic importance to the success of integrated supply chain management. The present invention recognizes that procurement has evolved from a basic function of purchase price minimization to a new value added, global and highly complex process which is of crucial importance for corporate growth. Further, total cost of ownership has replaced purchase price as the driver of procurement decisions, total cost of ownership including suppliers' costs and buyers' costs over a product's complete life cycle. Consequently, an embodiment of the present invention comprises methods and systems enabling an integrated supplier-buyer value chain and a closer relationship between the supplier and buyer by optimizing logistics flows, and thereby enhancing the supply chain efficiency and increasing procurement value added. In a further embodiment, the present invention may comprise a means and system to create information integrity and sufficient flow of logistics information within consolidated supplier-buyer relations.

Distribution. The methods and systems of the present invention recognize that distribution networks are one of the main areas affecting the value chain. The present invention recognizes that an optimum network provides customers with the right goods in the right quantity, at the right place, at the right time, with minimum total distribution costs. Further, aside from freight expenses, critical criteria for the design of efficient distribution networks are: order cycle time, customer service and transit network visibility—with the greater pressure on reliability and speed of deliveries requiring comprehensive information networks that feature order visibility and in-transit intervention. Accordingly, an embodiment of the present invention comprises a means and system for companies to reorganize their inbound and outbound distribution networks by partnering with logistics providers so that transitions between participants flow more smoothly. In a further embodiment of the present invention, said means and system comprises a comprehensive information network featuring order visibility and in-transit intervention, thereby increasing reliability and speed of deliveries requires. A further embodiment of the present invention comprises a means and system for providing users with a system and method to ensure consistent on-time deliveries at the best price with complete visibility. Said means and system, for example, may comprise a means and system for displaying and managing information gathered from Global Positioning Systems (GPS) (GPS is a system which compares radio signals from several satellites for determining position on the Earth's surface.) and Automatic Equipment Identification (AEI) systems on moving and stationary objects. An AEI uses a coded card mounted on a railroad car or locomotive and a trackside reader device which is strategically located to identify each piece of equipment as it passes the reader. The data are transmitted to a computer server, which can be accessed as needed to locate a particular car or to list an entire train as it passes. In a preferred embodiment, said means and system may comprise one or more of the following means and system: means and system for locating vehicles at any time, means and system for reacting to delays, and means and system for re-redirecting vehicles if necessary. In addition, an embodiment of the present invention comprises an information network which enables tracking and tracing of information relating to the current status of the shipment, delivery times and the recipient.

Warehousing. The methods and systems of the present invention recognize that lead-time is one of the most significant strategic elements in logistics. Lead-time not only influences sales and customer service, but also the overall cost of distribution. An embodiment of the present invention comprises one or more of the following programs: vendor-managed-inventories; and cross docking, thereby enabling more efficient distribution networks and generation of customer value added. The new customer focus implemented in modern supply chain management has shifted attention to movement maximization and delivery time minimization—currently companies rely on fewer, larger distribution centers, and on close reach to customers in order to deliver products safely and on time, in the most cost-effective manner, to any destination. The present invention recognizes that as transportation costs become less relevant, reduction of inventory costs become the primary objective, and new delivery modes like transshipment points and cross docking minimize inventory costs, but are sensitive to disruptions and irregularities. Accordingly, an embodiment of the present invention comprises one or more of the following: a means and system for providing an information integration solution which streamlines operations, and a means and system for reducing costs and allowing increased scope for future expansion and flexibility.

Reverse logistics. The methods and systems of the present invention recognize that growing concerns for protecting the environment and conserving resources have extended the logistics focus beyond the flow from companies to markets to include the need to manage reverse flows—from markets back to the company. Reverse Logistics is defined as the role of logistics in product returns, recycling, materials substitution, reuse of materials, waste disposal, and refurbishing. The present invention provides a system and a method which fosters proactive management and thus successful reverse logistics programs—proactive management including: communication with customers to avoid unauthorized returns, product damage and liability problems; control of transportation to prevent excessive freight charges; centralized returns processing to increase control over a product's live cycle and allow better data collections; and the gathering of information to manage the returns process while tracking costs. Accordingly, the present invention comprises a system and method for the management of third parties and transportation and shipping companies engaged in reverse logistics processes.

Logistics costs. The methods and systems of the present invention recognize that cost reductions remain the primary way to achieve a competitive advantage. Logistics costs can make the difference between a profitable product and one that is less profitable. The present invention recognizes that to identify potential cost reductions, logistics departments require detailed cost information-traditional cost systems can neither provide the necessary cost visibility, nor the insight regarding cost reduction effects of process improvements. In a cross-functional organization based on processes, managers need a view of the true process costs and the factors that drive those costs. Accordingly, the present invention comprises a system and a method which enables reductions in transaction cost and cycle time, plus opportunities to reduce and improve utilization of transportation assets. In a preferred embodiment, said system and method comprises full integration of information systems, said full integration including through out the logistics process, one or more of the following: shipment visibility and cost visibility.

5. Critical Capabilities

In a further embodiment of the present invention, the methods and systems of the invention comprise one or more of the following critical capabilities: logistics domain expertise, and logistics operations execution capabilities.

Said critical capabilities are discussed in further detail below:

Logistics domain expertise. A critical aspect of the present invention is the provision of logistics domain expertise—resources; knowledge and capabilities to design, manage and procure a global logistics network of transportation providers; logistics facilities, services, equipment and processes sufficient to ensure customer satisfaction; protection of product quality; and compliance with all regulations and customer expectations in the context of a competitively advantaged cost structure. By including such logistics domain expertise, the present invention provides community users with the capability to ensure that the latest technology and network optimization models are applied to provide maximum value. Accordingly, in a preferred embodiment, the community of the present invention comprises one or more of the following: knowledge in international trade and transportation (for example, knowledge in areas such as customs regulation, VAT regulation, national and international documentation); and expertise in the commercial business practices required to handle complex logistics situations (for example, an appreciation of cultural differences which impact the way a company performs business).

Logistics operations execution capabilities. The logistics operations execution capabilities of the systems and methods of the present invention comprises one or more of the following: order entry screen/XML interfaces; (XML, extensible markup language, is a flexible way to create common information formats and share both the format and the data on the world wide web, intranets, and elsewhere); real-time rating/routing including, for example, load builder and container stuffer capabilities; multi-order scheduling; optimization, consolidation, carrier selection, and equipment assignment functions; shipment review and manipulation; change carrier and change equipment type functions; web enabled book/tender/accept functions; web enabled resource commitment/availability functions; solution integration/ communication and execution interface capabilities; shipment status/execution/alerts/ shipment log functions; payment/settlement, web based invoice and entry/confirmation functions; data mart capabilities; carrier performance analyses; and cost analyses.

6. Additional Capabilities

Included within the methods and systems of the present invention are also the following additional features and capabilities: content/value-added services; and commerce enabling services. Said additional features and capabilities are discussed in further detail below:

Content/value-added services. Content/value-added services are included in the systems and methods of the present invention, such as, but not limited to, offerings that facilitate the work processes for an industry or industry segment. The content/value added services are provided in the form of information available on a site on a computer network such as the world wide web, a corporate intranet, a government/military network, or the like. Preferably, for ease of access to the widest number of participants, the content/value-added services are implemented on a site on the world wide web (internet). The content/value-added services of the present invention can be implemented utilizing currently available software authoring tools for the world wide web and other currently available software products.

The content/value-added services included in the present invention comprise one or more of the following: supply-chain-wide communication and integration (e.g., shared information between users and suppliers of shipping and logistics services, operations and products); all party access to “live” status on actions occurring in the supply-chain; products and services information; pricing and availability information; analysis of historical data reflecting shipping and logistics transactions (e.g. rail car turnaround data; sales forecasts); access to and preparation of specialized reports such as by business organization, region, and network; Material Safety Data Sheets; information relating to the Health Safety & Environmental (HSE) Services policies such as the Distribution Code section; market information; business intelligence reports; training and education such as hazardous material(HAZMAT) training; internal and external compliance audits and reports; and industry news and information.

Commerce enabling services. The provision of commerce enabling services of the present invention comprise a system and method for facilitating the procurement of shipping and logistics services, operations and products for a target industry. Said commerce enabling services comprise information and functions available on a site on a computer network such as the world wide web, a corporate intranet, a government/military network, or the like. Preferably, for ease of access to the widest number of participants, the commerce enabling services comprise services implemented on a site on the world wide web (internet). The commerce enabling services aspect of the present invention may be implemented utilizing currently available software authoring tools for the world wide web and other currently available software products.

The commerce enabling services provided by the present invention comprise one or more of the following services, said services providing for: multi-vendor exhaustive shipping/logistics products, operations and services catalogues and storefronts; an eCatalogue hub for shipping and logistics products, services and operations bought on a regular basis; a liquid exchange for high volume logistics products, services and operations bought on a regular basis; customer-specific pricing functionality; a request for quotation (RFQ) functionality for infrequent or single instance purchases; eVendor managed inventory systems connectivity for reduction in transaction costs; surplus auction capabilities; company business rule customization; intelligent agents (for example, a “My Logistics Assistant” intelligent agent); and shipping, transportation, storage and warehousing information, including carriers and transport information.

In a preferred embodiment of the present invention, said commerce enabling services comprise a service offering or package, wherein said service offering or package comprises a service offering or package developed from user needs and including one or more of the following: single point systems to systems integration; electronic multi-vendor managed inventory; and time saving applications. In a preferred embodiment, said commerce enabling services may additionally comprise a marketplace for transactions among suppliers and users of shipping and logistics services, operations and products, said marketplace connecting suppliers with users desiring to purchase logistics services, operations and products. Said marketplace may further comprise an information database comprising, for example, information about shipping and logistics suppliers and users. The supplier information in the database may include one or more of the following: corporate details (name, address, contact person etc.); product/material/service information (type, specification, details etc.); shipping information; transportation information; pricing information, and the like. The user information in the information database may include similar information wherein the product/material/service information comprises information about the goods produced by the manufacturer (for example, a chemical manufacturer) needing logistics services/operations / products (e.g., shipping, transportation, warehousing, etc.)

### DETAILED DESCRIPTION OF AN EMBODIMENT OF THE INVENTION

Further details of the present invention are set forth in the following paragraphs with reference to an embodiment of the present invention for the worldwide chemicals industry. The embodiment presented provides many advantages to users and suppliers of shipping and logistics services, operations and products in the chemicals industry.

The embodiment presented may be implemented through a web site, such as, “ShipChem.com.” The ShipChem.com embodiment provides next generation internet-powered logistics/fulfillment solutions enabling global transportation management over the internet, and the management of domestic and international orders and shipments as an integrated global logistics business process across a multi-enterprise supply chain.

In order to provide said solutions, ShipChem.com optimizes complex shipments, integrates service providers into the process, and leverages the internet to integrate trade data and enable trading partner access. In sum, ShipChem.com provides a 1-stop shop for shipping and logistics services, operations and products. Further details and advantages of the aforementioned are provided below.

1. Product/Service Offerings

ShipChem.com's major sources of revenue fall generally into the following broad categories of product/service offerings (a “service package” comprising one or more of the following):

procurement and management of a global logistics network;

operations performance of a logistics network;

planning and optimization of logistics;

global compliance; and

logistics analysis and reporting.

The aforementioned are described in further detail:

a. Procurement and Management of Global Logistics Network:

Procurement and management of a global logistics network comprises one or more of the following:

logistics service supplier procurement; and

negotiation processes for transportation, facilities and services.

The aforementioned are described in further detail:

Logistics service supplier procurement. ShipChem.com analyzes various logistics networks, current logistics infrastructures, and future logistics needs and develops a comprehensive procurement strategy which ensures an optimal cost structure and service package. ShipChem.com develops and maintains a core supplier group that is utilized in meeting ShipChem.com's customers' needs.

Negotiation processes for transportation facilities, and services. ShipChem.com negotiates contracts with logistics suppliers to meet ShipChem.com's customers' cost requirements and service specifications. ShipChem.com ensures that all suppliers chosen meet the criteria established by the various CMA protocols, industry standards, and customer specifications. ShipChem.com maintains appropriate documentation (such as but not limited to, insurance certificates and CMA protocol assessments) that ensure that only qualified suppliers are used.

b. Operations Performance of a Logistics Network

Operations performance of a logistics network comprises one or more of the following:

selection of carriers for shipment(s);

arrangement and building of shipment(s);

tracing/expediting inbound and outbound shipment(s);

rate information/freight invoice(s) audit processing;

maintenance of freight rate table(s);

measurement of suppliers performance;

maintenance of transit standards;

processing of carrier claims;

answering customer complaints;

managing supplier relationships; and

auditing warehouse/terminal compliance.

The aforementioned are described in further detail:

Selection of carriers for shipment(s). ShipChem.com handles booking, tendering, loading and shipping arrangements with each supplier used and ensures its customers' cost, service and compliance requirements are met.

Arrangement/building of shipment(s). ShipChem.com creates shipments in a timely manner to ensure the effectiveness of the customers' order handling processes. ShipChem.com also manages the consolidating or pooling of small shipments into large ones in order to take advantage of lower freight costs.

Tracing/expediting inbound and outbound shipment(s). ShipChem.com monitors all shipments to ensure on time delivery. Where it is determined that shipments will arrive late, ShipChem.com notifies appropriate parties. ShipChem.com offers the capability to instantly provide information where shipments are located throughout the supply chain.

Rate information/freight invoice(s) audit processing. ShipChem.com ensures accurate and timely freight invoice verification and provides timely payment records.

Maintenance of freight rate table(s). ShipChem.com maintains all freight rates in a customer friendly, online and secure database. ShipChem.com provides rate information to customers and allows timely product/order pricing.

Measurement of suppliers performance. ShipChem.com maintains a logistics supplier list for its customers and measures suppliers against specifications.

Maintenance of transit standards. ShipChem.com establishes and maintains accurate transit times.

Processing of carrier claims. ShipChem.com files supplier claims on behalf of its customers. Claims include those due to carrier contamination, customer downtime due to late shipments, delivering damaged material, and delivering the wrong amount of products.

Answering customer complaints. ShipChem.com investigates customer complaints and works closely with the various service providers to ensure that root cause failure analyses are properly done in order to minimize repeat complaints.

Managing supplier relationships. ShipChem.com maintains supplier relationships, fosters achievement of customers' requirements and ensures proper communication of customers' needs and specifications.

Auditing warehouse/terminal compliance. ShipChem.com audits warehouses and terminals and ensures that warehouses and terminals are in compliance with the CMA protocol, industry standards and customer performance specifications. ShipChem.com issues reports on audit findings and takes action on any audit findings that determine safety or quality concerns exist. ShipChem.com works with service providers to facilitate its customers' required audits, such as good manufacturing practices audits, Health Safety & Environmental (HSE) audits, and physical inventory audits.

d. Planning and Optimization of Logistics

Planning and optimization of logistics comprises one or more of the following:

logistics network optimization;

determination of logistics equipment/asset requirements;

customer focused logistics solutions; and

customer visits.

The aforementioned are described in further detail:

Logistics network optimization. ShipChem.com analyzes customers' logistics flows, forecasts, and other data and ensures that customers' logistics flows are properly optimized in order to achieve the lowest cost structure possible.

Determination of logistics equipment/asset requirements. ShipChem.com analyzes historical railcar turnaround data, sales forecasts and other data and determines the number of railcars needed to handle its customers' business. ShipChem.com handles railcar equipment leasing and procuring in compliance with financial terms authorized by its customers.

Customer focused logistics solutions. ShipChem.com works with its customers to identify, develop, and communicate logistics solutions. As new opportunities and the need for new customer solutions arise, ShipChem.com assists its customers in investigating and making appropriate recommendations to meet customer needs. Should a customer's current infrastructure require changes or additions, ShipChem.com provides support for analyzing and setting up the new process or infrastructure.

Customer visits. To better determine customer solutions, ShipChem.com offers site visits to participate and solve opportunities upon request.

e. Global Compliance

Global compliance comprises one or more of the following:

compliance with the distribution code;

dangerous goods compliance; and

distribution emergency response.

The aforementioned are described in further detail:

Compliance with the distribution code. ShipChem.com ensures that all global logistics suppliers handling its customers' products are in compliance with the Distribution Code and Health Safety & Environmental policy. ShipChem.com provides reports as requested outlining progress on various elements contained in the distribution code. ShipChem.com manages transportation risk management programs and works closely with its customers to ensure chemical transportation risks are minimized.

Dangerous goods compliance. ShipChem.com provides hazardous material training and certifying to all employees determined to be “HAZMAT employees.” ShipChem.com provides shipping documents that meet HAZMAT transportation requirements and determines compliance through audits and assessments.

Distribution emergency response. ShipChem.com coordinates transportation emergency response efforts with its customers as needed. ShipChem.com ensures that global third-party remediation and information services are in place should a transportation incident occur. If an incident does occur, ShipChem.com performs a root cause failure analysis to determine cause of the incident.

f. Logistics Analysis and Reporting

Logistics analysis and reporting comprises:

Data integrity and performance measurement. ShipChem.com measures key cost, service, quality and asset management criteria as defined by its customers. ShipChem.com provides detailed reports by business organization, region, network or other customer specified criteria.

2. Basic Interface

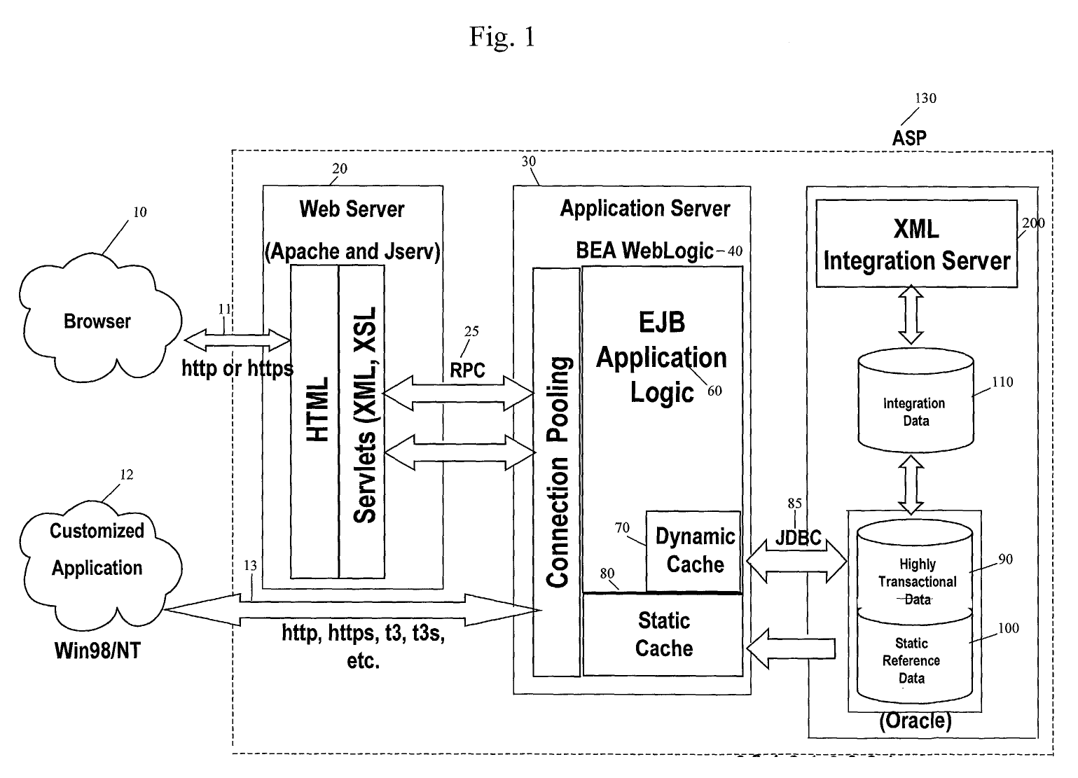

ShipChem.com's product/service offerings are executed generally via an interface provided on a site on the world wide web. Referring to FIG. 1, in one embodiment, an application service provider (ASP) 130 hosts ShipChem.com using a system comprising a web server 20, an applications server 30 and a database server 120. As is clear to one skilled in the art, these servers are implemented via software and may be implemented on a single computer or on multiple computers. In a preferred embodiment of the current invention, each of these logical servers are implemented on a separate physical computer to maximize the scalability, reliability and availability of ShipChem.com.

The web server 20 comprises a hypertext transfer protocol (HTTP) compliant web server, such as Apache, capable of providing both static and dynamic content in response to HTTP requests. Static pages may be written in a markup language. Markup languages include, but are certainly not limited to, hypertext markup language (HTML), extensible markup language (XML) and VoiceXML. In a preferred embodiment, dynamic content may be created using a servlet, which is an application running as part of the web server, or using an application programming interface (API), such as Sun Microsystem's JavaServer™ API. The API supports the execution of server pages, such as Java Server Pages, on the web server to create the dynamic content. For example, a request directed to a Java Server Page on the web server results in the creation of a dynamic XML document. The XML document is associated with an extensible style sheet (XSL), resulting in an HTML document that is provided to the process that made the original request. To create dynamic content the web server may communicate with the application server both to execute business logic and to retrieve data. The web server 20 communicates with the application server via a remote procedure call (RPC) 25, utilizing an object request broker (ORB). In a preferred embodiment of the present invention, the remote procedure call and the object that it invokes conform to the Object Management Group's (OMG) Common Object Request Broker Architecture (CORBA). One skilled in the art could utilize other RPC architectures, such as simple object access protocol or Microsoft's Common Object Model (COM) and Distributed COM (DCOM).

In a preferred embodiment, the application server 30 comprises a web application server, such as BEA WebLogic™, to provide a robust environment for the implementation of the business logic of ShipChem.com. In order to provide a robust environment, the web application server supports various services comprising connection pooling, Enterprise JavaBeans™ (EJB) 60, and dynamic 70 and static caches 80. An advantage of connection pooling is that it allows sharing server resources among client requests. JavaBeans is a component architecture which allows Java developers to create reusable software components or objects. RPC's initiated on the web server, which require the use of these objects, result in the instantiation of the requested object. The object then performs any necessary data access and logic processing in order to return a result to the calling process on the web server. A cache is a small, fast memory area utilized for recently or frequently accessed data. A dynamic cache is generally implemented as “write-through” cache. When the processor writes data to main memory, it also copies that data to the cache based on the assumption that the data will soon be requested again. Static cache is used to store data that is used often in order to speed access to that data. Static cache is refreshed in a process distinct from the reading and writing of main memory. The application server 30 communicates with a database server 120 utilizing an API which facilitates standard structured query language commands issued from the application elements to the database elements. In a preferred embodiment, the communication API is the java database connectivity (JDBC) API 85.

In a preferred embodiment of the present invention, the database server comprises a physical computer executing relational database management software (RDBMS) such as an Oracle™ RDBMS. The RDBMS is capable of managing a plurality of data subsets. The data subsets comprise structured data. The data subsets may also comprise a multi-dimensional database (MDB) used for a decision support system (DSS) comprising on-line analytical processing (OLAP) functionality. The data subsets may further comprise a document repository, which may be managed by the RDBMS or by a separate application specifically created to manage document repositories. In an Oracle RDBMS, each subset is most advantageously stored in a separate schema. The data comprises a highly transactional data subset 90 and a static reference data subset 100. The data may also comprise an integration data subset 110. The integration data subset is necessary to integrate data from a plurality of trading partners, each using a distinct enterprise resource planning (ERP) application. Data is added, maintained and removed from the integration data subset by an integration server 200. An integration server supports the integration of disparate data by facilitating the creation of translation rules, converting the data into a standard or common format. In a preferred embodiment, the integration server is an XML integration server, which allows the trading partners to supply and extract data from the RDBMS using standard and/or predefined XML schemas. As with the previously discussed software components, the XML integration server may reside on the same physical computer as the database server, or on a separate server.

A preferred embodiment of the present invention provides a plurality of access methods. These access methods comprise supplying and extracting data via the aforementioned XML integration server and accessing the web server via hypertext transfer protocol (HTTP) using a uniform resource locator (URL) 11. The access methods may further comprise connecting directly to the application server via a standard communication protocol such as HTTP or simply transmission control protocol/internet protocol (TCP/IP) over a dedicated transmission line, such as a T-3 line or the like 13. The embodiment also comprises software operative to present a graphical user interface. Various functionality provided by ShipChem.com may be accessed by users or by external automated processes. To facilitate functionality directed to a user, a preferred embodiment comprises a browser application 10, such as Microsoft® Internet Explorer, to provide the graphical user interface when accessing the web or application server via HTTP. The browser accepts a URL, and the HTTP request is routed to the ASP and further, to the web site to which the ASP has bound the internet protocol (IP) address associated with the URL. An embodiment may further comprise a customized application 12, which is capable of accessing the application server directly over TCP/IP and performing various functions such as generating reports. The customized application may further comprise a graphical user interface. In a preferred embodiment, the customized application executes within one of the family of Microsoft® Windows operating systems.

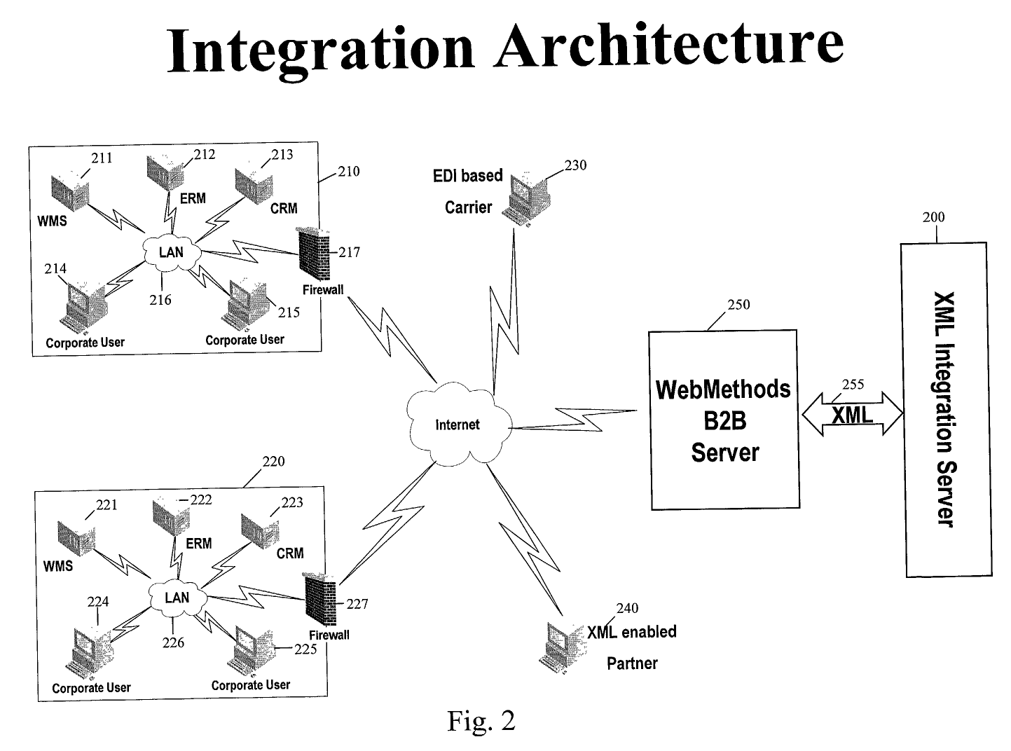

As mentioned above, an integration server facilitates the translation of disparate data. Referring to FIG. 2, in an embodiment of the present invention, the integration server 200 receives XML data 255 from a business-to-business (B2B) server 250. In a preferred embodiment, the B2B server is the Web Methods™ B2B server. The B2B server facilitates a secure, bi-directional information exchange between disparate applications in a business community. The B2B server uses XML to integrate new and legacy information systems. Electronic data interchange (EDI) is a traditional method of transferring data between trading partners. Various business communities have developed EDI standards for many years and EDI is a proven, reliable method of exchange. EDI relies on software present in the systems of any trading partners participating in a transaction. EDI also requires the use value-added-network (VAN) or EDI-based carrier 230 to facilitate the transaction. In an embodiment of the present invention, in order to support these existing EDI transactions, the B2B server may comprise a facility to exchange information with an EDI-based carrier 230. Other trading partners may be using XML currently to facilitate transactions. The B2B server may comprise a facility to exchange information with an XML-enabled partner 240 as well.

Again, referring to FIG. 2, to further facilitate the integration of a variety of trading partners, the B2B server 250 may also comprise a facility to exchange data with critical business applications existent within a trading partner's internal computer network 210, 220. The trading partners internal computer network comprises a local area network (LAN) 216, 226 to facilitate communication between corporate users 214, 224, 215, 225 and various internal and external applications. The applications may comprise a warehouse management system (WMS) 211, 221, an enterprise resource management system (ERM), a customer relationship management (CRM) system 213, 223 or an external internet application accessible via a firewall 217, 227.

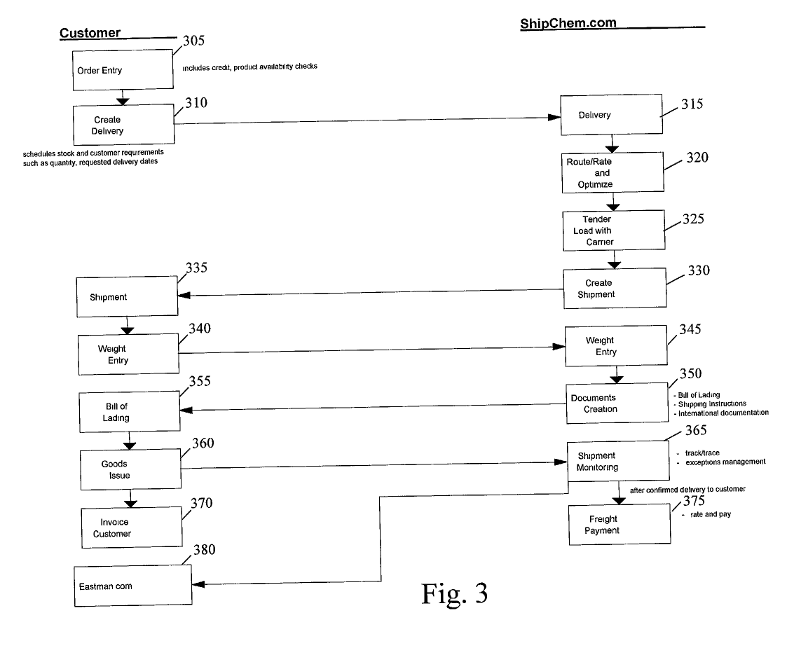

FIG. 3 illustrates a basic consumer transaction implemented by an embodiment of the present invention. As shown in FIG. 3, a customer accesses ShipChem.com to place an order. ShipChem.com presents the customer with an order entry interface 305. The order entry interface may comprise a plurality of screens, including product and shipping information. The order entry interface may further comprise credit availability information as well as a facility for credit procurement. The order entry screen may be generated by using XML and XSL to generate HTML pages, which are presented to the customer. Once the customer has entered an order, the customer creates a delivery 310. The delivery creation process comprises the customer entering requirements, such as quantity, product grade and requested delivery dates, and also comprises the customer viewing information regarding stock scheduling, i.e., when stock of a certain product will be available.

Once the customer has completed entering the order and creating a deliver, ShipChem.com begins processing the delivery 315. The route and rate for delivering the order is calculated and optimized 320. The route and rate calculations are performed using real-time routing and rating information, including load builder and container stuffer capabilities. The delivery functionality also comprises multi-order scheduling and consolidation, carrier selection, and equipment assignment. The load is tendered with a carrier 325. At this point, the shipment may be created 330. The customer may provide various information regarding the shipment 335, including entering the weight of the shipment 340. ShipChem.com accepts the weight entry 345 and uses the entry to create any necessary documents 350. The documents necessary to make a shipment comprise a bill of lading and shipping instructions. If the shipment is an international shipment, the documents may further comprise any necessary international documentation. The bill of lading is presented to the customer 355 and the customer may manipulate the shipment. The customer may change the carrier and equipment type. When the customer approves the bill of lading, the customer authorizes the issuance of the goods 360. After authorization, the customer is presented with the invoice 370.

An embodiment of the present invention monitors the shipment 365, providing tracking and tracing capabilities. The shipment monitoring may also comprise exception management capabilities, alerting the customer or a system administrator when events, such as the arrival of goods at a foreign port, do not occur as expected. ShipChem.com also facilitates payment/settlement of the freight charges 375, calculating the rate and paying the charge. When the process is complete, the customer is redirected to the home page 380 where additional functionality is accessible.

Additional functionality may comprise data mart capabilities, such as summarizing and reporting various data relating to orders and shipments. Data mart capabilities provide the customer with further capabilities such as performing carrier performance and cost analysis. Data mart capapbilities are discussed in further detail in the following sections.

3. Functions and Capabilities

Execution of ShipChem.com's product/service offerings via an interface on a site on the world wide web comprise one or more of the following functions:

Asset management and optimization. The asset management and optimization function provides transportation asset management capabilities including: allocated ATP of carrier capacity; container/rail car demand planning; container/rail positioning optimization; and asset maintenance/test scheduling (intelligent filtration and exception identification from the car location management (CLM) system automatically identifies exceptions and presents them to the user). The asset management and optimization function also generates messages via any means of electronic notification based on updated CLM data. Examples of messages include: bad ordered cars, off route cars, and late cars.

Book/tender/accept/execution integration. ShipChem.com includes functions which facilitate booking, tenders, accepting, execution and integration capabilities through a web-enabled interface, classic EDI (electronic data interchange, a standard format for exchanging business data), or XML. Specific capabilities include automatic re-tenders, transportation exchange enablement, and international trade logistics integration.

Carrier and rate management. ShipChem.com's carrier rate and management function includes online contract management (carrier and shipper manage a single, shared rate repository so as to reduce administrative effort and improves accuracy), and online rate quotation (dynamic pricing/spot market utilization) capabilities.

Claims management. The claims management function provides support for freight claims and customer service-related claims.

Currency exchanger. ShipChem.com's currency exchange function allows users to select a “from currency” and an amount, and have the amount converted to a second currency specified by the user (includes daily exchange rate tables from financial institutions, user preferences for viewing currencies, and multi-currency capabilities in the scheduling and rating application).

Data mart. ShipChem.com includes extensive data mining capabilities, including data collection, data storage, data sorting and data retrieval and analysis, such as carrier performance, cost analysis and historical learning.

Decision support. ShipChem.com's decision support functions include shipment review and manipulation, analysis of change carrier and equipment types, Gantt chart, and map control capabilities.

Electronic funds transfer. ShipChem.com's electronic funds transfer capabilities include electronic billing, automated freight bill audit process, and freight accruals sent to GL capabilities.

Emergency response. ShipChem.com provides emergency response services to exchange participants. The emergency response function provides users with coordinated emergency response efforts, including global third-party remediation and information services. This function also provides users with root cause failure analyses upon request.

Financial services. ShipChem.com's financial services functions are extensive and include participation with financial institutions to provide financial services, for example, Letters of Credit, financing, and electronic clearing.

Freight financial settlement. ShipChem.com's freight financial settlement function provides financial settlements for carrier payments (A/P) and customer billing (A/R).

International trade support. ShipChem.com's international trade support function provides online import/export compliance checks and international documentation capabilities.

Local time wizard. ShipChem.com's local time wizard function allows a user to enter a locale (where locale is country, state/province, city etc.), and then receive the current time for the locale entered. This function allows users to correctly schedule pickup and/or delivery of freight anywhere in the world understanding and using the local time of all locations involved.

Metric converter. ShipChem.com's metric converter function allows users to select “a from” unit of measure and an amount and have the amount converted to a second unit of measure that the user specifies.

MSDS retrieval. This function provides MSDS (Material Safety Data Sheet) for product on-demand over the internet.

Net landed cost calculator online. ShipChem.com's net landed cost calculator provides bid process (for example, effective utilization of competitive environment for bidding future rates) capabilities.

Order integration. ShipChem.com provides order integration functions, such as order entry screens, electronic interfaces, and ERP integration capabilities (ERP, enterprise resource planning, is an industry term for the broad set of activities supported by multi-module application software that help a manufacturer or other business manage the important parts of its business, including product planning, parts purchasing, maintaining inventories, interacting with suppliers, providing customer service, and tracking orders).

Payment/settlement. Payment and settlement capabilities are provided, including web based invoice entry/confirmation, customer billing, simple and complex allocation, and claims processing and recording.

Planning. ShipChem.com provides an extensive planning function with capabilities such as multi-order scheduling, stop-off truckloads, itineraries for global shipping, automatic routing, pool distribution, carrier optimization, and specific equipment availability.

Quoting. ShipChem.com provides an extensive quoting function ranging from simple interactive shipment rating to international trade logistics integration capabilities.

Security. A key requirement allows access to the ShipChem.com site to include the following security features: defined user roles and functions; and domain management (a domain representing a set of data and objects within the application that are owned and controlled by a specific entity or corporation.). The key function allows management of multiple domains per customer. Domain management includes: domain creation, domain listing, and the establishment of privileges associated with each domain. ShipChem.com's security function also includes capabilities required to segregate and secure each corporation's data entered into the application. Additionally, each user can be shown a tailored set of functionality appropriate for the users' job title and daily tasks.

Shipment rating and routing. ShipChem.com's shipment rating and routing function includes the following capabilities: (1) multi-parameter carrier selection in order to ensure that optimal mode, carrier and equipment is selected for individual loads (factoring in the following items: performance, cost, shipper-contracted carriers, restrictions and constraints, HEALTH SAFETY & ENVIRONMENTAL requirements, and collaborative load planning); (2) load consolidation (consolidates “less than truck load” (LTL's) and underutilized “truck load” (TL's) shipments into loads, including multi-pickup and multi-drop across multiple shippers capabilities); (3) continuous move planning (builds TL loads into continuous move trips to increase asset utilization); (4) tendering and scheduling (supports load tender and response via internet, EDI or Autofax, and facilitates collaboration between shipper, carrier and consignee to schedule pickup, delivery and equipment drops); (5) port finder (provides location information for all ports in the world including: port code, port authority, address, contact name, title, phone, fax, and port website addresses); (6) airport finder (provides location information for all airports in the world including: IATA (International Air Transport Association) codes, address, contacts name, title, phone, etc.); (7) schedule finder (provides access to vessel schedules from and to any port in the world; supports look up tailored to users' needs, including: carrier, trade lanes of interest, port or ports of interest, required ship date and arrival date; information provided includes: departure dates for all ports of call, arrival dates for all ports of call, carrier, voyage, service, vessel, and voyage itinerary); and (8) load optimizer (as part of the scheduling algorithm, determines how to package an order, and how the packaged items fit into the transport equipment).

Shipment status/alerts. ShipChem.com's shipment functions include logistics provider integration, exception notification, shipment log capabilities, and transaction log capabilities.

Shipment viewer. The shipment viewer function provides order status monitoring, proactive shipment monitoring (customers can order status, before and after shipment), pipeline inventory visibility (visibility into inventory in supply chain is provided with multi-level grouping capabilities), exception monitoring (multi-parameter exception identification, including both events and non-events), and intelligent messaging (message generation based on changing transactional status and on exception identification).

Statistical analysis and reporting. The statistical analysis and reporting function provides analytical tools and reports using data captured in the system. Reports can include: carrier performance, trade lane performance, and projected v. actual cost analysis.

Transit time and dynamic ETA calculation. ShipChem.com's transit time and dynamic ETA (estimated time of arrival) function provides a highly accurate transit time calculator able to determine transit times by route segment, and dynamic ETA calculation capabilities.

User management. Each company using ShipChem.com is able to establish their own hierarchy of users and permissions to match their organizational needs. This allows for the entry and management of users, including the following capabilities: authentication of user; user id and password; user preference; language; currency to display; unit of measure options; and date/time options. The User Management function can also help users by providing each user with their own set of personal preferences for using and interacting with ShipChem.com.

4. Value Creation Operation Plan

A critical aspect of the ShipChem.com embodiment of the present invention is the ability of system to optimize value by enabling users to create a personalized package of value adding shipping and logistics services, operations and products, thereby enabling customers to choose and pay for only those services, operations and products needed.

Examples of actual application results in specific value-added systems resulting from the use of the systems and methods of the present invention as determined by computer modeling are provided in some detail in the following sections relating to rail freight, truck freight, steam ship lines, bulk parcel tankers, isotainers, enablers, and storage facilities (packaged warehouses, liquid bulk terminal, and transfer facilities).

a. Rail Freight

(1) Mode Inefficiencies

Railroads have significantly reduced their labor costs. However, operational inefficiencies that effect performance do exist. These inefficiencies are estimated to increase cost by 10-20%. Examples include: putting cars on the wrong train; congestion within rail yards; speed limits on sections of track due to lack of capital to repair infrastructure; and seasonality effects that create labor shortage in peak demands.

(2) ShipChem.com Value-Added Solution

RESULT: 2% value creation on tank car, hopper car and coal car freight

SHIPCHEM.COM Applications:

Shipment rating and routing. Use of ShipChem.com reduced costs through optimization of the best route and rate, taking into consideration the cost of service failures and actual trade lane performance.

Assets management: rail car positioning optimization. ShipChem.com's intelligent filtration and exception identification from the CLM (car location management) system automatically identified exceptions and presented them to users and rail service companies. ShipChem.com also generated messages via a customer compatible means of electronic notification based on the updated CLM data.

Contract and rate management. Use of ShipChem.com reduced duplication of effort in maintaining contracts and rates in multiple locations. Labor reductions on the carrier side as well on the user side resulted.

Freight financial settlements. Utilization of ShipChem.com's rate and pay functions and use of electronic transfers resulted in reduced paper invoices and manual auditing. Labor reductions on the carrier side as well as on the user side resulted. Note: In 1999, one chemical manufacturer reported $1.2M (1% of total rail spend) in invoicing errors, which could be avoided using the services of ShipChem.com.

RESULT: 4% value creation on intermodal

SHIPCHEM.COM Applications:

Shipment rating and routing. Use of ShipChem.com reduced costs through optimization of the best route and rate, taking into consideration the cost of service failures as well as optimal steam ship line sailing schedule/optimal port of shipment and actual trade lane performance.

Contract and rate management. Use of ShipChem.com reduced duplication of effort in maintaining contracts and rates in multiple locations. Labor reductions on the carrier side as well on the user side resulted.

Freight financial settlements. Utilization of ShipChem.com's rate and pay functions and use of electronic transfers, reduced paper invoices and manual auditing. Labor reductions on the carrier side as well as on the user side resulted. Note: In 1999, one chemical manufacturer reported $1.2M (1% of total rail spend) in invoicing errors, which could be avoided using the services of ShipChem.com.

b. Truck Freight (Bulk Truck Liquid and Dry)

(1) Mode Inefficiencies

The “truck load” (TL) carriers can be grouped into two areas: national/systems carriers and regional carriers. The national carriers typically utilize their own control room systems to balance their fleet of trucks. National carriers typically provide coverage of a large portion of the country. Capacity utilization is in the 75-80% range for the national carriers. Regional carriers, in contrast, make movements in the 200-300 mile range and typically are less sophisticated in the use of computerized systems to manage their truck fleet. Capacity utilization is in the 60-65% range for the regional carriers.

There are tradeoffs in using national versus regional carriers. Regional carriers guarantee equipment availability and are available to act as a dedicated fleet for a user. This can help in on-time performance and in the cleaning /contamination issues of delivering product. The regional carriers also have lower labor costs through lower wages paid, but provide advantages to drivers in the number of nights they are at home. National carriers, in contrast, can provide a more balanced fleet by leveraging the product flows of all customers, but may not always have equipment available to meet a particular customer's needs. National carriers have somewhat lower rates due to better asset utilization than the regional carriers.

Individual users often do not have the systems capabilities to control products previously loaded in a truck which leads to cleaning inefficiencies. Individual users also often do not have the systems capabilities to allocate trade lanes consistently to carriers which in turn makes it difficult for the carrier to build up backhauls and deadhead miles. Additional operational inefficiencies are caused by lack of accurate information provided to the carriers from a user on product flow movements. The provision of such information would allow both the regional and national carriers to better optimize the utilization of the assets within their network.

National carriers typically have more advanced computer technology used in running their business. It is common for individual users to place requirements of equipment availability on national carriers. This lowers a carrier's overall efficiency estimate to approximately 75% utilization of assets due to the increase in the number of empty backhauls and deadhead miles in delivering product for users imposing such requirements. These requirements have created a hybrid carrier (combination between national and regional).

(2) ShipChem.com Solution Offering

RESULT: 5% value creation on Liquid and Dry Bulk Truck freight (Value proposition from traditional transportation management systems are in the range of 2 to 8%)

SHIPCHEM.COM Applications:

Shipment rating and routing. Use of ShipChem.com reduced costs through optimization of the best route and rate, taking into consideration the cost of service failures.

Tendering and scheduling. Use of ShipChem.com allowed support load tender and response via Internet, EDI or Autofax, and collaboration between shipper, carrier and consignee to schedule pickup, delivery and equipment drops.

Contract and rate management. Use of ShipChem.com reduced duplication of effort in maintaining contracts and rates in multiple locations. Labor reductions on the carrier side as well as on the user side resulted.

Freight financial settlements. Utilization of ShipChem.com's rate and pay concept and electronic transfer function, reduced paper invoices and manual auditing. Labor reductions on the carrier side as well as on the user side resulted. Note: In 1999, $530K (1.3% of bulk truck freight spend) in invoicing errors were reported which could be avoided using ShipChem.com.

c. Truck Load (TL) and Less Than Truck Load (LTL)

(1) Mode Inefficiencies

Overall efficiency estimates for TL's are generally 80-90% utilization of assets. The TL carrier's objective is to try to minimize the deadhead miles. On-time performance is typically at the 98-100% level. Freight rates are influenced by whether a user's freight move is considered to be a backhaul for a given carrier. Consideration of a user's freight move as backhaul influence rates downward due to carriers trying to maximize utilization and reposition assets. Typically, individual users do not have the systems capabilities to allocate trade lanes consistently to carriers which in turn makes it difficult for the carrier to build up backhauls and deadhead miles. Additional operational inefficiencies are due to driver shortage and fuel costs.

Overall efficiency estimates for LTL's are estimated to be slightly higher than TL assets. The LTL carrier is trying to maximize his cubic space in bringing together cargo and minimize the imbalance of equipment positioning. On-time performance is typically at the 95-98% level. Freight rates can be reduced by 25-50% by utilizing the spot market within LTL. On a daily basis some LTL carriers post business to improve their asset utilization (backhaul or cube maximization situations). Individual users, however, often can not take advantage of these postings for the following reasons: short lead time (changes daily with no advance warning); planning process (prefer to use negotiated rates and not lookup new rates daily); rate structures and updating within SAP (due to manual update process within SAP, prefer to have only one set of rates per carrier); and lack of systems integration (would need to connect electronically between the LTL carriers and SAP to efficiently use). (SAP, a “systems, applications and products” data processing software package, enables users to interact within a common database for a comprehensive range of applications including the capability to manage financial, asset, and cost accounting, production operations and materials, personnel, plants, and archived documents.)

(2) ShipChem.com Solution Offering

RESULT: 6% value creation on Liquid and Dry Bulk Truck freight (Value proposition from traditional Transportation Management Systems are in the range of 6 to 14%)

SHIPCHEM. COM Applications:

Shipment rating and routing. Use of ShipChem.com reduced costs through optimization of the best route and rate, taking into consideration the cost of service failures.

Tendering and scheduling. Use of ShipChem.com allowed support load tender and response via internet, EDI or Autofax, and collaboration between shipper, carrier and consignee to schedule pickup, delivery and equipment drops.

Load consolidation. Use of ShipChem.com allowed the consolidation of LTL and underutilized TL shipments into loads, including multi-pickup and multi-drop, across multiple shippers and customers.

Continuous move planning. Use of ShipChem.com allowing the building of TL loads into continuous move trips to increase asset utilization.

Load optimizer. As part of the scheduling algorithm, ShipChem.com's load optimizer function determined how to package an order, and then how the packaged items fit into the transport equipment.

Contract and rate management. Use of ShipChem.com reduced duplication of effort in maintaining contracts and rates in multiple locations. Labor reductions on the carrier side as well as on the user side resulted.

Freight financial settlements. Utilization of ShipChem.com's rate and pay and use of electronic transfers, reduced paper invoices and manual auditing. Labor reductions on the carrier side as well as on the user side resulted. Note: In 1999, $530K (1.3% of bulk truck freight spend) in invoicing errors were reported which could be avoided using ShipChem.com.

d. Steam Ship Lines (SSL)

(1) Mode Inefficiencies

Inefficiencies within the SSL have been primarily due to the following: deregulation in 1999 which created contract and rate inefficiencies due to the number of individual contracts versus conference rates; approximately 25 buyouts or mergers within the industry in the past three years; turnover of personnel within the industry; and communication between different parties within the industry (e.g. freight forwarder capabilities in communication with SSL). Additionally, overall capacity of SSL vessels is full. This varies from trade lane to trade lane. SSL are constantly balancing the capacity in a given trade lane with demand. SSL are using vessel-sharing agreements to maximize their capacity utilization. Currently vessel building is occurring to meet the increasing demand for container movements. Individual users typically, however, do not have the systems capabilities to allocate trade lanes consistently to carriers which in turn makes it difficult for the carrier to build up backhauls and reduce empty repositioning of container equipment. Additional operational inefficiencies are due to weather, delays at ports, and inaccuracies in the forecasts provided to the SSL. Container management is another area where inefficiencies occur. Lack of a forecast or schedule can create a large inventory of containers at a given port. Cycle time for an empty container to be loaded and turned over to the SSL at the port is typically 22-30 days.

(2) ShipChem.com Solution Offering

RESULT: 6% value creation on Full Container Loads (FCL) and Less Container Loads (LCL) (Value proposition from traditional Transportation Management Systems are in the range of 6 to 13%.)

SHIPCHEM. COM Applications:

Elimination of freight forwarders. Freight forwarders obtain a 1.5 to 2.5% booking commission. Use of ShipChem.com eliminated the need to use a freight forwarder.

Shipment rating and routing. Use of ShipChem.com reduced costs through optimization of the best route and rate, taking into consideration the cost of service failures.

Port and schedule finder. Use of ShipChem.com provided access to location information for all ports and vessel schedules from and to any port in the world, thereby supporting routing decisions, cycle time reduction and equipment positioning.

Tendering and scheduling. Use of ShipChem.com allowed support load tender and responses via internet, EDI or Autofax, and collaboration between shipper, carrier and consignee to schedule pickup, delivery and equipment drops.

Load consolidation. Use of ShipChem.com allowed the consolidation of LCL and underutilized FCL shipments into loads, including multi-pickup.

Load optimizer. As part of the scheduling algorithm, ShipChem.com's load optimizer determined how to package an order, and then how the packaged items fit into the transport equipment.

Contract and rate management. Use of ShipChem.com reduced duplication of efforts in maintaining contracts and rates in multiple locations. Labor reductions on the carrier side as well as on the user side resulted.

Freight financial settlements. Utilization of ShipChem.com's rate and pay function, and use of the electronic transfer function, reduced paper invoices and manual auditing. Labor reductions on the carrier side as well as on the user side resulted. Note: In 1999, $ 900K (1.8% of ocean freight, excluding bulk parcel freight spending) in invoicing errors were reported which could be avoided using ShipChem.com.

e. Bulk Parcel Tanker

(1) Mode Inefficiencies

Parcel tankers prefer the bigger parcels with more profitability when loading the ship. This can lead to vessel substitution events. Vessel substitution can occur as long as the new vessel arrives within the lay days. However, this can result in a customer's requested delivery date not being met. Communication between different parties within the industry is also inefficient and can cause demurrage costs (compensation paid for detention of a ship, freight car, or other cargo conveyance during loading or unloading beyond the scheduled time of departure, e.g. broker, tank terminal, and surveyor and bulk parcel tanker operator). Inefficiencies are also caused by the existence of different levels of computer technology within the different players in the industry (for example, some have tracking and tracing capabilities.) Transshipments can result in loss of quantity and quality of the product.

(2) ShipChem.com Solution Offering

RESULT: 2% value creation on Bulk Parcel Freight (Brokers obtain a 2.5% commission on freight spent, ShipChem.com offers the possibility to eliminate the broker)

SHIPCHEM. COM Applications:

Shipment rating and routing. Use of ShipChem.com reduced costs through optimization of the best route and rate, taking into consideration the cost of service failures.

Port and schedule finder. Access to ShipChem.com's location information for all ports and vessel schedules from and to any port in the world supported routing decisions and reduced cycle time and equipment positioning.

Tendering and scheduling. Use of ShipChem.com allowed support load tender and responses via internet, EDI or Autofax, and collaboration between shipper, carrier and consignee to schedule pickup, delivery and equipment drops.

Contract and rate management. Use of ShipChem.com reduced duplication of effort in maintaining contracts and rates in multiple locations. Labor reductions on the carrier side as well as on the user side resulted.

Freight financial settlements. Utilization of ShipChem.com's rate and pay function, and use of the electronic transfer function, reduced paper invoices and manual auditing. Labor reductions on the carrier side as well as on the user side resulted.

f. Isotainer Freight

(1) Mode Inefficiencies

Inefficiencies within the isotainer mode include the empty repositioning of isotainers by the carrier to handle an individual user's business (lowers the percent utilization of the isotainers). Asset utilization is typically between 65 to 70%. An individual user, however, typically realizes inefficiencies due to the precise loading hours of isotainer carriers, resulting in demurrage costs.

(2) ShipChem.com Solution Offering

RESULT: 4% value creation on Isotainer Freight

SHIPCHEM. COM Applications:

Shipment rating and routing. Use of ShipChem.com reduced costs through optimization of the best route and rate, taking into consideration the cost of service failures.

Port and schedule finder. Access to ShipChem.com's location information for all ports and vessel schedules from and to any port in the world supported routing decisions and reduced cycle time and equipment positioning.

Tendering and scheduling. Use of ShipChem.com allowed support load tender and responses via internet, EDI or Autofax, and collaboration between shipper, carrier and consignee to schedule pickup, delivery and equipment drops.

Contract and rate management. Use of ShipChem.com reduced duplication of effort in maintaining contracts and rates in multiple locations. Labor reductions on the carrier side as well as on the user side resulted.

Freight financial settlements. Utilization of ShipChem.com's rate and pay function, and use of the electronic transfer function, reduced paper invoices and manual auditing. Labor reductions on the carrier side as well as on the user side resulted.

g. Enablers

(1) Mode Inefficiencies

From a railcar productivity standpoint, the cost per pound of product moved is increasing. This is mainly due to increased turnaround times of the railcars. Both transit times and its variability are increasing. Primary areas impacting the turnaround time of railcars include: decreases in the rail performance due to consolidations and mergers of railroads effecting operational performance as well as reducing the number of competitors and accountability to improve; increases in the number of smaller customers that are holding onto railcars longer (especially hopper cars); and increases in distance to travel to the customer. The number of car trips per year has declined from 1996 to 1999. For hopper cars, it has declined from 16 to 12 trips per year. For tank cars, it has declined from 6 to 4.5 trips per year. The tank car decline is based primarily on the poor performance of the railroads. The hopper car decline is due to both railroad performance and increased customer hold times. The percent utilization of railcars from 1996 to 1999 is approximately 70-77% for hopper cars and 80-85% for tank cars. The percentage delivered as scheduled has increased from 79% in 1997 to 84% in 1999. Average customer hold times have increased from 1996 to 1999-for hopper cars from 24 to 32 days, and for tank cars from 8 to 10 days. One reason for the significantly better performance in the tank car area is the practice of charging demurrage and the HAZMAT concerns of storing chemicals.

(2) ShipChem.com Solution Offering

RESULT: 2% value creation on rail car costs (leasing & maintenance)

SHIPCHEM. COM Applications:

Shipment rating and routing. Use of ShipChem.com reduced costs through optimization of the best route and rate, taking into consideration the cost of service failures.

Shipment viewer. Use of ShipChem.com allowed proactive shipment monitoring, and multi-parameter exception identification, including both events and non-events.

Assets management. Use of ShipChem.com allowed rail car demand planning, rail positioning optimization, asset maintenance and test scheduling. Use of ShipChem.com's intelligent filtration and exception identification from the CLM system automatically identified exceptions and presented them to the user. Use of ShipChem.com also permitted the generation of messages via any means of electronic notification based on updated CLM data.

Contract and rate management. Use of ShipChem.com reduced duplication of effort in maintaining contracts and rates in multiple locations. Labor reductions on the carrier side as well as on the user side resulted.

Freight financial settlements. Utilization of ShipChem.com's rate and pay function, and use of the electronic transfer function, reduced paper invoices and manual auditing. Labor reductions on the carrier side as well as on the user side resulted.

h. Packaged warehouses, Liquid bulk terminals, and Transfer Facilities

Problems in efficiently utilizing tank space, warehouse space and transfer facilities (track space) (for example, carriers backed up waiting to be unloaded, or materials not moved out of tanks/warehouses on a regular basis) can also be solved using ShipChem.com. Tank terminals and warehouses have economic breakpoints by which they determine when it is an advantage to maximize the throughput through the tank or warehouse, or try to sell leasing of an additional tank or warehouse space. Contracts are typically for a max throughput in a given year with additional (variable) charges for any throughput over this amount. Therefore, it is to the service provider's advantage to capture the variable charges to a point. There is a point where labor and operational requirements may be too much to continue pushing for more throughputs, however.

Operational inefficiencies which can be improved through the use of ShipChem.com include: monitoring damaged material, transfer losses etc. (not utilizing capabilities of new control room technology, telemetry data, bar code data); demurrage caused by carriers waiting to unload product; and communication gaps between warehouse/terminal/transfer facility and carriers.

5. Memberships & Equity Partner Strategies and Advantages

An aspect of the ShipChem.com embodiment of the present invention is the membership structure of the users and suppliers of the community. The following chart provides additional details regarding the advantages and functions of the equity membership (equity members comprise users who invest capital and commit major parts of their logistics transactions thereby helping the community of the present invention to rapidly achieve critical mass for network efficiencies). Equity members benefit from expected appreciation of their capital investment, and the opportunity to influence the evolution of the community and the service offerings therein.

| | | | | Technology | | |
|---|---|---|---|---|---|---|
| | Chemical | Logistics | eCommerce | Domain | | Value Adders |
| | Industry | Services | Market | Expertise | Chemical | Services for |
| | Producers | Providers | Makers | Capability | Distributors | Website |
| Equity Partner Strategy | | | | | | |
| Complimentary Supply Chain | X | X | | | X | |
| The equity partner would bring logistics trade | | | | | | |
| lanes that add Volume to the existing business | | | | | | |
| of ShipChem.com's that result in leveraging | | | | | | |
| opportunities and enhance asset utilization for | | | | | | |
| our logistics suppliers. This reduces the cost | | | | | | |
| for our customers and increases the profit | | | | | | |
| margin for the company. | | | | | | |
| Extend Globalization | X | X | | X | X | |
| The equity partner provides a strong regional | | | | | | |
| presence along with regional domain | | | | | | |
| expertise. These assets to the company | | | | | | |
| include the following: logistics expertise, | | | | | | |
| people, physical sites in the region, and | | | | | | |
| regional business for ShipChem.com. | | | | | | |
| Demonstrate Neutrality | X | ? | X | | X | |
| An equity partner would broaden the | | | | | | |
| ownership of the company beyond Eastman | | | | | | |
| and G-Log. This would move the perception | | | | | | |
| of the company into a more neutral position in | | | | | | |
| the eyes of the investors, stockholders, and | | | | | | |
| customers. | | | | | | |
| Credibility | X | X | X | | X | X |
| The proper equity partner could quickly bring | | | | | | |
| “brand name” recognition to ShipChem.com. | | | | | | |
| This would enhance the long-term viability of | | | | | | |
| the company in the marketplace (investor | | | | | | |
| community, stockholders, customers and | | | | | | |
| employees) and provide an impetus in the | | | | | | |
| company's sales and marketing plans. | | | | | | |
| Credibility | X | X | X | | X | X |
| The proper equity partner could quickly bring | | | | | | |
| “brand name” recognition to ShipChem.com. | | | | | | |
| This would enhance the long-term viability of | | | | | | |
| the company in the marketplace (investor | | | | | | |
| community, stockholders, customers and | | | | | | |
| employees) and provide an impetus in the | | | | | | |
| company's sales and marketing plans. | | | | | | |
| Volume Leverage | X | X | X | | X | |
| The equity partner provides additional | | | | | | |
| business that would increase the company's | | | | | | |
| logistics and procurement spend. This in turn | | | | | | |
| could reduce the costs of our customers and | | | | | | |
| carriers. This business would increase | | | | | | |
| awareness in the investor community of the | | | | | | |
| potential of ShipChem.com and enhance the | | | | | | |
| short and long-term independence of the | | | | | | |
| company. | | | | | | |
| Additional People/Domain Expertise | X | X | | X | X? | |
| This equity partner would provide additional | | | | | | |
| resources that are required for ShipChem.com | | | | | | |
| to provide comprehensive services on a global | | | | | | |
| basis. Examples of these resources include | | | | | | |
| transition training, services and people, sales | | | | | | |
| and technical services personnel, IT | | | | | | |
| integration, connection, and scalability | | | | | | |
| services. | | | | | | |
| Extend Service Offering | | X | | X | | X |
| An equity partner would provide additional | | | | | | |
| services that are currently in the vision for | | | | | | |
| ShipChem.com. These services could include | | | | | | |
| warehouse management, forecasting, inventory | | | | | | |
| management, asset management, and inventory | | | | | | |
| container management. | | | | | | |
| Reliability, Scalability, Disaster Recovery, | | | | | | |
| Future | | | | | | |
| This equity partner provides ShipChem.com | | | | | | |
| with expertise to improve the company's IT | | | | | | |
| systems, as well as potentially adding these | | | | | | |
| services into the ShipChem.com's | | | | | | |
| product/service customer offering. | | | | | | |
| Reliability, Scalability, Disaster Recovery, | | | | | | |
| Future | | | | | | |
| This equity partner provides ShipChem.com | | | | | | |
| with expertise to improve the company's IT | | | | | | |
| systems, as well as potentially adding these | | | | | | |
| services into the ShipChem.com's | | | | | | |
| product/service customer offering. | | | | | | |
| Provide equity in ShipChem.com | Yes/No | No | No | Yes | No | No |
| The decision-making process for equity | | | | | | |
| partnerships within ShipChem.com should | | | | | | |
| include the following: culture compatibility, | | | | | | |
| eBusiness expertise and vision, the partner's | | | | | | |
| perception in the industry and investor | | | | | | |
| community, the ability of the partner to bring | | | | | | |
| other customers/partners to ShipChem.com, | | | | | | |
| “leader or follower” company history profile, | | | | | | |
| and be a positive spokesperson for | | | | | | |
| ShipChem.com. | | | | | | |
| Partnership Strategy | | | | | | |
| Potential Partners | BP/Amoco, | BDP, UP | Chemconnect | IBM, Oracle | VOPAK | WWT.Com |
| The companies shown in this section are | Dow, BASF, | | | | | |
| examples only, and may or may not represent | Exxon/Mobil | | | | | |
| true, potential partners. | | | | | | |
| ShipChem.com Priorities | | | | | | |
| Characteristics for choosing an equity partner | | | | | | |
| in each segment are shown below. These are | | | | | | |
| in addition to the criteria listed above. These | | | | | | |
| are ranked in addition to the criteria listed | | | | | | |
| above. These are ranked as high, medium, and | | | | | | |
| low within each segment in terms of | | | | | | |
| importance. | | | | | | |
| Fill knowledge and expertise gaps. | Low | High | Medium | High | Medium | High |
| Complimentary Supply Chain | Medium | Low | Low | Low | Medium | Low |
| Extend Globalization | High | High | Low | Low | Medium | High |
| Demonstrate Neutrality | High | Medium | Medium | Medium | Low | Low |
| Credibility | High | High | High | High | Medium | High |
| Volume Leverage | High | High | Medium | Low | High | Low |
| Additional people/Domain expertise | Medium | High | Low | Medium | Low | Medium |
| Extend Service Offering | Low | High | High | High | High | High |
| Reliability, scalability, disaster recovery, | Low | Low | Low | High | Low | Low |
| future technology | | | | | | |
| Provide a another growth engine. | Low | Medium | High | Medium | Medium | Medium |
| Open up a another industry to eBusiness | Low | High | High | Low | High | High |
| vision. | | | | | | |
| Bring new market and business opportunities. | Medium | Medium | High | Medium | High | Medium |
| Well positioned in medium to small chemical | Low | High | Low | Low | High | Low |
| companies. | | | | | | |
| Bring outsourcing experience. | High | High | Medium | Low | Medium | Medium |
| Lowers ShipChem.com costs; improves | High | Low | Low | Medium | Medium | Medium |
| profitability | | | | | | |
| Compatible company culture and vision | High | High | Low | Medium | High | Medium |

6. Revenues

Another aspect of the ShipChem.com embodiment of the present invention is the receipt by the community of one or more types of revenue, thereby allowing the community to remain independent and self-supporting. Revenue types and sources available to the community include transaction fees, commission revenues, and subscription fees/referral fees. The following chart provides additional details regarding the revenues available to the community.

| | U.S. CHEMICAL | WW CHEMICAL |
|---|---|---|
| | INDUSTRY | INDUSTRY |
| Chemical Industry | $440 B | $1,600 B |
| Approximate Logistics | 44 B | 160 B |
| Spending | | |

ShipChem.com solutions can generate savings of>5% and probably<15%:

| | | |
|---|---|---|
| Potential Revenue at 5% | $2.2 B | $ 8 B |
| Potential Revenue at 15% | 6.6 B | 24 B |

Each 1% market share captured by ShipChem.com generates potential revenue:

| | | |
|---|---|---|
| 1% Share at 5% | $22 M | $ 80 M |
| 1% Share at 15% | 66 M | 240 M |

ShipChem.com maintains neutrality among shippers and logistics services suppliers, and constitutes a desirable solution to all. Savings generated are shared equitably among ShipChem.com., chemical shippers, and service providers. Assuming ⅓share to ShipChem.com., each 1% share generates the following revenue:

| | | |
|---|---|---|
| 1% Share at 5% | $7.3 M | $26.7 M |
| 1% Share at 15% | 22 M | 80 M |

Assuming capture of 1% of U.S. market during the first 12 months, gross revenue would be between $7.3 M and $22 M.

Assuming capture of 3% of U.S. market and 1% of outside U.S. market during year two, gross revenue would grow to between $42 M and $126 M.

Assuming capture of 5% of U.S. market and 3% of outside U.S. market during year three, gross revenue would grow to between $97 M and $290 M.

Capture of 25% market share in the U.S. alone at ⅓split would generate gross revenue for ShipChem.com of $183 M to $550 M per year.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

What is claimed:

1. A system for facilitating commerce in an industry marketplace comprising a community of participants in a target industry comprising:
a computer network;
a market segment within the industry;
a database for information relevant to the industry or to the market segment accessible via the computer network, the database comprising at least one of the following: data, a value-added service; a commerce service; and
an interface, wherein the interface provides access to the information.

2. The system of claim 1, wherein said computer network comprise a wide area network.

3. The system of claim 1, wherein said community comprises a “virtual” community.

4. The system of claim 3, wherein said virtual community is implemented as a site on the world wide web.

5. The system of claim 1, wherein said community comprises a single market segment within a single industry.

6. The system of claim 1, wherein the scope, make-up and size of said community vary depending on the make-up, size and scope of the market segment.

7. The system of claim 1, wherein said community fluctuates as the make-up, size and scope of said market segment fluctuates.

8. The system of claim 1 further wherein said comprising one or more users.

9. The system of claim 1, wherein said community of participants comprises one or more of the following: users and/or suppliers of shipping and logistics services, operations and products.

10. The system of claim 1, wherein said community of participants comprises members of distinct levels.

11. The system of claim 10, wherein said distinct levels are membership levels structured to meet needs of users and suppliers in a target industry supply chain.

12. The system of claim 10, wherein said members comprise one or more of the following:
an equity member;
a commission based member;
a transaction user member; and
a referral member.

13. The system of claim 1, wherein said community of participants comprises one or more providers of shipping, logistics, and/or operations services and/or products.

14. The system of claim 13, wherein said services, operations and products comprise one or more of the following:
logistics operations execution;
logistics network optimization;
logistics compliance management; and
logistics procurement functionality.

15. The system of claim 1, further comprising systems and methods for receipt of one or more types or revenue.

16. The system of claim 15, said types of revenue comprise one or more of the following:
transaction fees;
commission revenues;
subscription fees; and
referral fees.

17. The system of claim 1, wherein said community of participants comprises one or more virtual fourth party shipping and logistics providers.

18. The system of claim 1, wherein said system includes a logistics software infrastructure.

19. The system of claim 1, further comprising systems and methods able to leverage one or more of the following supply chain components:
procurement;
distribution;
warehousing;
reverse logistics; and
logistics costs.

20. The system of claim 1, further comprising one or more of the following capabilities:
logistics domain expertise; and
logistics operations execution capabilities.

21. The system of claim 1, further comprising one or more of the following capabilities:
content/value-added services; and
commerce enabling services.

22. The system of claim 21, wherein said content/value-added services comprise one or more of the following:
supply-chain-wide communication and integration;
access to “live” status on actions occurring in the supply-chain;
products and services information;
pricing and availability information;
analysis of historical data;
access to and preparation of specialized reports;
Material Safety Data Sheets;
information relating to HSE services policies;
market information;
business intelligence reports;
training and education;
internal and external compliance audits and reports; and
industry news and information.

23. The system of claim 21, wherein said commerce enabling services comprise one or more of the following services, said services providing for:
multi-vendor shipping and/or logistics products, operations and/or services;
catalogues
storefronts;
an eCatalogue hub;
a liquid exchange for high volume logistics products, services and/or operations;
customer-specific pricing functionality;
request for quotation (RFQ) functionality for infrequent or single instance purchases;
eVendor managed inventory systems connectivity for reduction in transaction costs;
surplus auction capabilities;
company business rule customization;
intelligent agents; and
shipping, transportation, storage and warehousing information.

24. The system of claim 21, wherein said commerce enabling services comprise a service offering or package.

25. The system of claim 24, wherein said service offering or package comprises a service offering or package developed from user needs; and including one or more of the following:
single point systems to systems integration;
electronic multi-vendor managed inventory; and
time saving applications.

26. The system of claim 24, wherein said commerce enabling services further comprises a marketplace for transactions among suppliers and users of shipping and logistics services, operations and products, said marketplace connecting suppliers with users desiring to purchase logistics services, operations and products.

27. The system of claim 16, wherein said marketplace further comprises an information database.

28. The system of claim 24, wherein said service offering or package comprises one or more of the following:
procurement and management of a global logistics network;
operations performance of a logistics network;
planning and optimization of logistics;
global compliance; and
logistics analysis and reporting.

29. The system of claim 28, wherein said procurement and management of a global logistics network comprises one or more of the following:
logistics service supplier procurement; and
negotiation processes for transportation, facilities and services.

30. The system of claim 28, wherein said operations performance of a logistics network comprises one or more of the following:
selection of carriers for shipment(s);
arrangement and building of shipment(s);
tracing/expediting inbound and outbound shipment(s);
rate information/freight invoice(s) audit processing;
maintenance of freight rate table(s);
measurement of suppliers performance;
maintenance of transit standards;
processing of carrier claims;
answering customer complaints;
managing supplier relationships; and
auditing warehouse/terminal compliance.

31. The system of claim 28, wherein said planning and optimization of logistics comprises one or more of the following:
logistics network optimization;
determination of logistics equipment/asset requirements;
customer focused logistics solutions; and
customer visits.

32. The system of claim 28, wherein said global compliance comprises one or more of the following:
compliance with the distribution code;
dangerous goods compliance; and
distribution emergency response.

33. The system of claim 28, wherein said logistics analysis and reporting comprises data integrity and performance measurement.

34. A system for facilitating logistics in an industry marketplace comprising:
a plurality of trading partners;
a computer network;
a processor functionally connected to said computer network and operative to integrate the logistics data of said trading partners and provide the data in response to a request;
a database server functionally connected to said processor operative to store data from and provide data to said processor;
a network access device functionally connected to said processor and said network and operative to issue said request.

35. A system for facilitating logistics in an industry marketplace comprising:
a computer network;
a network access device functionally connected to said computer network and operative to perform functionality comprising at least one of: present a graphical user interface and perform scheduled operations;
a web server functionally connected to said computer network and operative to provide a document in response to requests;
an application server functionally connected to said web server and operative to execute business logic and provide content to said web server for said provision of said document;
a database server functionally connected to said application server and operative to provide data to said application server;
an integration server functionally connected to said database server and operative to integrate data from disparate sources into a standard structured data format;
a business-to-business server, functionally connected to said integration server and operative to exchange data with a business application, wherein said business application comprises at least one of: an electronic data interchange-based carrier, an XML-enabled application, a warehouse management system, an enterprise resource management system, and a customer relationship management system; and
a plurality of trading partners functionally connected to said business-to-business server.
